(19) United States
(12) Patent Application Publication
(10) Pub. No.: US 2024/0271676 A1
(43) Pub. Date: Aug. 15, 2024

(54) Friction Pad Body

(71) Applicant: Erika Fischer, Weilheim (DE)

(72) Inventor: Erika Fischer, Weilheim (DE)

(21) Appl. No.: 18/582,424

(22) Filed: Feb. 20, 2024

Related U.S. Application Data
(63) Continuation of application No. 16/500,698, filed on Oct. 3, 2019, now abandoned.

(30) Foreign Application Priority Data
Apr. 10, 2017 (DE) 10 2017107 621.2

(51) Int. Cl. F16D 69/02; F16D 65/092; F16D 69/00

(52) U.S. Cl. CPC F16D 69/028; F16D 65/092; F16D 69/027; F16D 2069/001; F16D 2200/0039; F16D 2200/0043; F16D 2200/0047; F16D 2200/0065; F16D 2200/0086

(57) ABSTRACT

A friction pad body having a backing part and a friction part, which integrally consist of the same ceramic material, without a seam and joint. The ceramic material has a purity of at least 80% in relation to the total weight of the friction pad body. The friction pad body is preferably produced in the form of a sintered body by isostatic pressing so that a single-stage production process can be achieved.

### CROSS-REFERENCE TO RELATED APPLICATIONS

This application is a continuation of Ser. No. 16/500,698, filed on Oct. 2, 2019, which is a national stage of International Application No. PCT/EP2018/058879 filed Apr. 6, 2018, which claims priority to Germany Patent Application No. 10 2017 107 621.2, filed Apr. 10, 2017. The entirety of each of which are incorporated by reference herein.

### TECHNICAL FIELD

The invention relates to a friction lining body for use in a friction brake. The friction lining body can also be referred to as a brake pad.

### BACKGROUND

Friction lining bodies for friction brakes are known. For example, DE 38 03 069 A1 describes a friction lining body for a disk brake. The friction lining body comprises a backing plate that includes a friction lining. The backing plate is typically made of metal, for example made of steel. The brake pad is made of a material that is suitable with respect to the friction pairing with a brake disk. So as to prevent oxidization of the backing plate due to contact with the brake caliper, it is proposed to provide an appropriate metal layer on the backing plate to avoid contact corrosion with the material of the brake caliper.

DE 103 58 320 A1 proposes joining a friction lining integrally and in a form-locked manner to a backing. Reinforcement fibers are provided in the process, which penetrate the interface between the backing and the friction lining. For example, the reinforcement fibers present in the friction lining are to penetrate into the layer of the backing by way of needling and additionally cause a form fit there between the layers of the backing and the friction lining.

### SUMMARY

Proceeding from this, it can be considered to be the object of the present invention to create a friction lining body that is very easy to produce, while meeting the mechanical and thermal requirements during use in a friction brake.

This object is achieved by a friction lining body having the features of claim 1.

The friction lining body comprises a backing part and a friction part, which are integrally made of the same ceramic material, without any seam and joint. No transition surface or transition zone is present between the backing part and the friction part. The ceramic material of which the friction lining body is made does not form a separating layer or joining layer between the backing part and the friction part. In particular, the friction lining body is produced by sintering so as to form a sintered body. The friction lining body is preferably an isostatically pressed sintered body.

Since the backing part and the friction part of the friction lining body are designed to be integral, no stresses result from heating during braking due to differing coefficients of thermal expansion. No contact corrosion arises when the ceramic friction lining body is used in a brake caliper, as is the case in the related art with metallic backing parts.

The ceramic material preferably has a purity of at least 75% or at least 85% or at least 95%.

The friction lining body is made, in particular, of a highly compressed sintered ceramic material. The ceramic material preferably has a density of approximately 3 to 6 g/cm³.

The ceramic material has good mechanical and thermal properties for the task of a friction lining body. By adding coloring substances during sintering, the friction lining body can also be produced in color without necessitating painting. Precise geometric shapes can be achieved in a simple manner by way of pressing and sintering.

As an alternative to producing the friction lining body from a sintered ceramic material, this could also be produced from a reaction ceramic material.

Preferably, the ceramic material used is an oxide ceramic material, such as aluminum oxide. The use of aluminum oxide allows relatively high coefficients of sliding friction in the range of approximately 0.4 to 0.7 to be achieved, depending on the material pairing.

It is also possible to use non-oxide ceramic materials, for example aluminum nitride, silicon carbide, silicon nitride, boron nitride or boron carbide. The use of aluminum oxide and silicon carbide has the advantage that these materials have a low coefficient of thermal expansion when the friction lining is heated during the braking process.

In a simple embodiment of the friction lining body, preferably no reinforcement fibers are present. This simplifies production. In a modification thereto, it is also possible to arrange reinforcement fibers, and in particular carbon fibers, in the ceramic material of the friction lining body. In this way, the shear strength can be increased. Moreover, the thermal conductivity can be improved by way of carbon fibers, and a more uniform heat distribution within the friction lining body can be achieved.

In one exemplary embodiment, the backing part comprises an attachment section, which protrudes laterally beyond the friction part. At least one attachment recess can be present in this attachment section for attaching the friction lining body to a brake caliper or to another retaining part.

### BRIEF DESCRIPTION OF THE DRAWINGS

Advantageous embodiments of the invention will be apparent from the dependent claims, the description and the drawings. Preferred exemplary embodiments of a friction lining will be described in detail hereafter based on the accompanying drawings. In the drawings:

FIG. 1 shows an exemplary embodiment of a friction lining body in a perspective view with a view of the backing part;

FIG. 2 shows the friction lining body from FIG. 1 in a perspective view with a view of the friction part;

FIG. 3 shows the friction lining body according to FIGS. 1 and 2 in a top view of the friction part; and

FIG. 4 shows a cross-sectional view through the friction lining body along intersecting line IV-IV of FIG. 3.

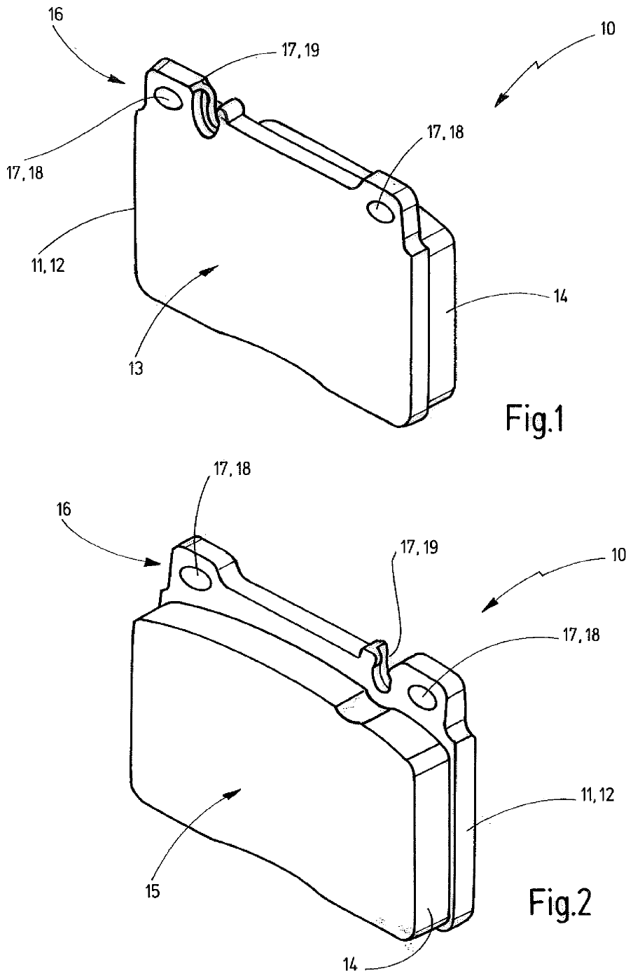

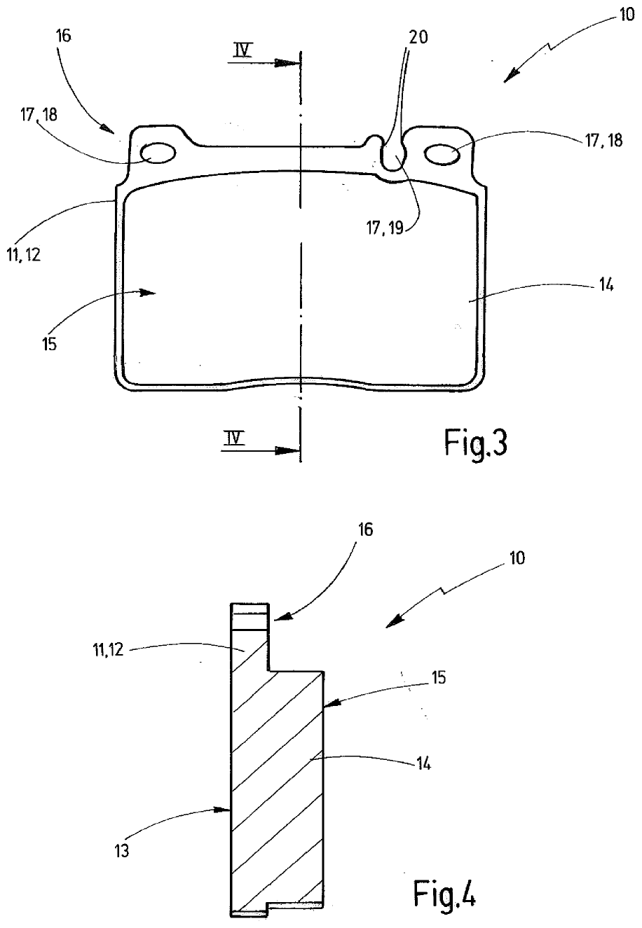

### DETAILED DESCRIPTION

The figures illustrate an exemplary embodiment of a friction lining body 10, which is used in a friction brake. The friction lining body 10 can therefore also be referred to as a brake pad. The friction lining body 10 includes a backing part 11, which in the exemplary embodiment is designed as a backing plate 12. The backing plate 12 has a substantially planar rear surface 13. The friction lining body includes a friction part 14 on the side opposite the rear surface 13. On the side opposite the backing part 11, the friction part 14 includes a friction surface 15, which is made to bear against a brake component for generating a frictional force during a braking process. The friction part 14 has a constant thickness, as viewed perpendicularly to the friction surface 15 thereof. This can have an approximately cuboid or cube-like contour. The friction part can also be curved in an arc shape to conform to the contour of a brake disk.

The backing part 11 and, according to the example, the backing plate 12 protrude laterally beyond the friction part 14 in a direction parallel to the friction surface or the rear surface 13. In this region, the backing part 11 includes an attachment section 16. The backing part 11 or the backing plate 12 includes one or more attachment cut-outs 17 in the attachment section 16. According to the example, two attachment cut-outs 17 are designed as holes 18.

Another attachment cut-out 17 is open on the side and thus designed as an open cut-out 19. The open cut-out 19 can include at least one, and according to the example two detent projections 20 located opposite one another, whereby the cross-section of the open cut-out 19 is decreased in the location of the at least one detent projection 20. In this way, a force fit and/or a form fit can be established with a pin engaging in the cut-out 19.

The friction lining body 10 is made of an integrally produced body, without any seam and joint. In particular, no interface, separating surface or joining surface is present between the backing part 11 and the friction part 14. The friction lining body is produced from a ceramic material. The ceramic material preferably has a purity of at least 80 to 85%, or at least 90 to 95%. In the exemplary embodiment, the ceramic material is an oxide ceramic, for example aluminum oxide. As an alternative, however, the ceramic material can also be a non-oxide ceramic, such as a carbide or a nitride, for example aluminum nitride, boron nitride, silicon nitride, silicon carbide or boron carbide.

The friction lining body 10 is preferably composed of a sintered ceramic material. In particular, the friction lining body 10 is produced as an isostatically pressed, and preferably highly compressed sintered body. According to the example, the friction lining body 10 is produced in a single-stage pressing and sintering operation. A machining process for producing the attachment cut-outs 17 is dispensed with. Likewise, no post-processing for establishing the connection between the friction part 14 and the backing part 11 is necessary.

In addition to the ceramic material, it is possible to introduce additives, such as reinforcement fibers, into the ceramic material. In one exemplary embodiment, carbon fibers are embedded into the ceramic material as reinforcement fibers, whereby the mechanical stability and thermal conductivity can be improved. The proportion of such additives, based on the weight of the friction lining body 10, is no more than 5% or no more than 10% or no more than 15% or no more than 25%.

Apart from impurities, the ceramic material can also be free of additives, and in particular reinforcement fibers.

The chemical and/or mechanical and/or physical properties of the friction part 14 are identical to those of the backing part 11. During production, the same ceramic material, with or without additives, is used for both parts 11, 14.

The friction lining body has isotropic properties. In particular as a result of the isostatic pressing or hot isostatic pressing, a porosity is created which is advantageous for the use in a friction brake.

The invention relates to a friction lining body 10, comprising a backing part 11 and a friction part 14, which are integrally made of the same ceramic material, without any seam and joint. The ceramic material has a purity of at least 75% to 80%. The friction lining body is preferably produced by way of isostatic pressing in the form of a sintered body, so that a single-stage production process can be achieved.

### List of Reference Numerals

10 friction lining body

11 backing part

12 backing plate

13 rear surface

14 friction part

15 friction surface

16 attachment section

17 attachment cut-out

18 hole

19 open cut-out

20 detent projection

1. A friction pad body comprising:
a backing part; and
a friction part,
wherein the backing part and friction part integrally comprise a same ceramic material having a purity of at least 75% without any seam and joint and a density of approximately 3 to 6 g/cm³, and
wherein the friction pad body is an isostatically pressed sintered body.

2. The friction pad body according to claim 1, wherein the backing part protrudes laterally beyond the friction part at least on an attachment section.

3. The friction pad body according to claim 2, wherein at least one attachment cut-out is present in the attachment section.

4. The friction pad body according to claim 1, wherein the ceramic material comprises an oxide ceramic or a non-oxide ceramic.

5. The friction pad body according to claim 1, wherein the ceramic material comprises one selected from the group of aluminum oxide, aluminum nitride, silicon carbide, silicon nitride, or boron nitride, and boron carbide.

6. The friction pad body according to claim 1, wherein the ceramic material is free of reinforcement fibers.

7. The friction pad body according to claim 1, wherein the ceramic material comprises reinforcement fibers.

8. The friction pad body according to claim 7, wherein the reinforcement fibers comprise carbon fibers.

9. The friction pad body according to claim 1, wherein the ceramic material comprises a sintered ceramic material.

10. The friction pad body according to claim 1, wherein the ceramic material has a purity of 75% to 80%.
